(19) United States
(12) Patent Application Publication
(10) Pub. No.: US 2026/0023263 A1
(43) Pub. Date: Jan. 22, 2026

(54) IMAGE DISPLAY DEVICE, METHOD OF CONTROLLING THE SAME, AND NON-TRANSITORY COMPUTER READABLE MEDIUM FOR PRESENTING MIXED REALITY

(71) Applicant: CANON KABUSHIKI KAISHA, Tokyo (JP)

(72) Inventor: YOSHIKI KAJITA, Kanagawa (JP)

(21) Appl. No.: 19/254,676

(22) Filed: Jun. 30, 2025

(30) Foreign Application Priority Data
Jul. 17, 2024 (JP) 2024-114271

(51) Int. Cl. G02B 27/01; G06F 3/01

(52) U.S. Cl. CPC G02B 27/0172; G06F 3/017; G02B 2027/0138; G02B 2027/014

(57) ABSTRACT

An image display device, on a basis of a position and orientation, which are determined from a first captured image and first orientation information corresponding to the first captured image when the first captured image has been captured, renders a first virtual image representing a virtual space as viewed from a viewpoint corresponding to the position and orientation, acquires a first corrected virtual image by correcting the first virtual image on a basis of second orientation information acquired after the first orientation information, acquires a composite image by combining a second captured image acquired after the first captured image with the first corrected virtual image, and displays the composite image on a display unit.

### BACKGROUND

### Field of the Technology

The present disclosure relates to an image display device, a method of controlling the same, and a non-transitory computer readable medium for presenting mixed reality.

### Description of the Related Art

In recent years, so-called a mixed reality (MR) technology has become known as a technology that seamlessly merges the real world and the virtual world in real time. One MR technology is an MR system that uses a video see-through type HMD (Head Mounted Display: hereinafter referred to as “HMD” as necessary). In the MR system, an object to be observed from the pupil position of a HMD wearer is image-captured by an imaging unit built into the HMD, and an image in which CG (Computer Graphics) is superimposed on the captured image is presented to the HMD wearer, allowing the user to experience an MR space.

In the MR system, many processes are performed from image capturing to displaying, including exposure and image processing of the captured image, calculations to determine the position and orientation of the HMD, CG rendering and combining with the captured image, image processing of the display image, and data transmission between various components. The time required for these processes results in a delay in the display image following the movement of the head of the HMD wearer, potentially causing discomfort to the HMD wearer due to the perception of latency. For example, Japanese Patent Laid-Open No. 2015-231106 discloses a technique for correcting a captured image on the basis of line-of-sight information, generating a virtual image to be combined with the image, and displaying the composite image.

However, the above-described conventional technique has the following problems. The configuration of Japanese Patent Laid-Open No. 2015-231106 corrects a captured image on the basis of the viewer's line-of-sight direction, and generates a virtual image to be combined with the image, thereby reducing the delay time up to that point. However, the delay caused by the processing time required for rendering the virtual image itself and the delay caused by the subsequent processing time until the image is displayed on the HMD are not taken into account.

### SUMMARY

The present disclosure has been made in view of the above-mentioned circumstances, and provides a technique for reducing the delay time from the acquisition of a captured image up to the start of displaying the same, as compared to the conventional techniques.

The present disclosure in its one aspect provides an image display device including an image sensor configured to capture a real space to acquire a captured image, an orientation sensor configured to detect an orientation of the image sensor to acquire orientation information, one or more processors and/or circuitry configured to, on a basis of a position and orientation of the image sensor, which are determined from a first captured image and first orientation information corresponding to the first captured image when the first captured image has been captured, perform a rendering process for rendering a first virtual image representing a virtual space as viewed from a viewpoint corresponding to the position and orientation, perform a correction process for correcting the first virtual image on a basis of second orientation information acquired after the first orientation information, to acquire a first corrected virtual image, and perform a composition process for combining a second captured image acquired after the first captured image with the first corrected virtual image, to acquire a composite image, and a display configured to display the composite image.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram showing an example of the configuration of an MR system.

FIG. 2 is a diagram explaining the process of generating a composite image from a captured image and an image of a virtual space.

FIG. 3 is a diagram illustrating an example of the functional configuration of an HMD and an image processing device according to the first embodiment.

FIG. 4 is a diagram illustrating a delay time in the conventional technology.

FIG. 5 is a diagram illustrating a delay time in an embodiment of the present disclosure.

FIG. 6 is a diagram illustrating a correction process according to the first embodiment.

FIG. 7 is a flowchart of the processing of an MR system according to the first embodiment.

FIG. 8 is a diagram illustrating a correction process according to the second embodiment.

FIG. 9 is a diagram illustrating a virtual image correction process.

FIG. 10 is a diagram illustrating an example of the functional configuration of an HMD and an image processing device according to the third embodiment.

FIGS. 11A and 11B are diagrams illustrating an example of the hardware configuration of an HMD and a computer device.

### DESCRIPTION OF THE EMBODIMENTS

The following embodiments will be described in detail with reference to the attached drawings. The following embodiments do not limit the invention according to the claims. Although the embodiments describe a number of features, not all of these features are essential to the invention, and the features may be combined in any way. Furthermore, in the attached drawings, the same or similar components are given the same reference numbers, and duplicated descriptions are omitted.

In the following embodiments, an example is described in which the image display device according to the present disclosure is applied to an MR system. As described later, the image display device (MR system) may be configured as a single unit, or may be configured from multiple units that are communicably connected to each other via a wired or wireless connection. In the latter configuration, for example, a first unit including an imaging unit, an orientation sensor, a display unit, and the like is worn on the user's head, and a second unit that performs calculations with a high processing load (such as image rendering) is configured as a separate image processing device.

### First Embodiment

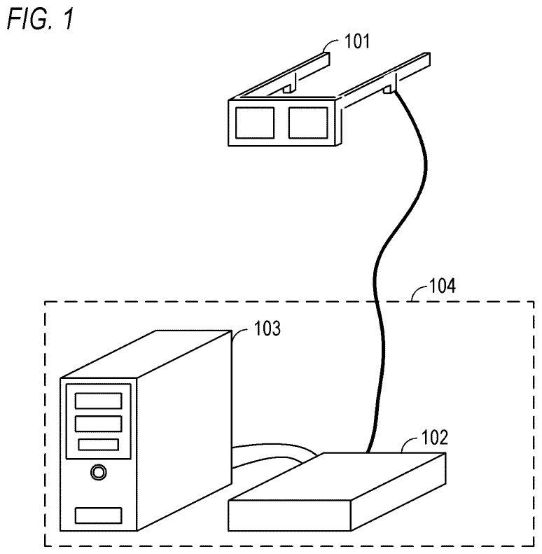

First, an example of the configuration of an MR system according to the present embodiment will be described with reference to FIG. 1. As shown in FIG. 1, the MR system according to the present embodiment has an HMD 101 (first unit) which is an example of a head-mounted display device, and an image processing device 104 (second unit). The image processing device 104 according to the present embodiment has a computer device 103 which generates an image of a mixed reality space (a space in which a real space and a virtual space are combined) to be displayed on the HMD 101, and a controller 102 which mediates between the HMD 101 and the computer device 103.

First, the HMD 101 will be described. The HMD 101 has an imaging unit which captures a real space, an orientation sensor which measures the orientation of the HMD 101 (imaging unit), and a display unit which displays an image of a mixed reality space transmitted from the image processing device 104. The HMD 101 also functions as a synchronization control device for these multiple devices. The HMD 101 transmits an image captured by the imaging unit and orientation information indicating the orientation of the HMD 101 (imaging unit) measured by the sensor to a controller 102. The HMD 101 also receives the mixed reality space image generated by the computer device 103 based on the captured image and the orientation information from the controller 102 and displays the image on the display unit. As a result, the mixed reality space image is presented in front of the eyes of a user wearing the HMD 101 on his/her head.

The HMD 101 may operate with power supplied from the image processing device 104 (controller 102) or with power supplied from the battery of the device itself. In other words, the method of supplying power to the HMD 101 is not limited to a specific method.

In FIG. 1, the HMD 101 and the image processing device 104 (controller 102) are connected by wire. However, the connection between the HMD 101 and the image processing device 104 (controller 102) is not limited to a wired connection, but may be a wireless connection, or may be a combination of wireless and wired connections. In other words, the connection between the HMD 101 and the image processing device 104 (controller 102) is not limited to a specific connection.

Next, the controller 102 will be described. The controller 102 performs various types of image processing (resolution conversion, color space conversion, distortion correction of the optical system of the imaging unit of the HMD 101, encoding, and the like) on the captured image received from the HMD 101. The controller 102 then transmits the processed captured image and the orientation information received from the HMD 101 to the computer device 103. The controller 102 also performs similar image processing on the mixed reality space image received from the computer device 103 and transmits the image to the HMD 101.

Next, the computer device 103 will be described. The computer device 103 obtains the position and orientation of the HMD 101 (the position and orientation of the imaging unit of the HMD 101) based on the captured image and orientation information received from the controller 102, and generates an image of a virtual space seen from a viewpoint having the acquired position and orientation. The computer device 103 then generates a composite image (mixed reality space image) of the virtual space image and the captured image received from the HMD 101 via the controller 102, and transmits the generated composite image to the controller 102.

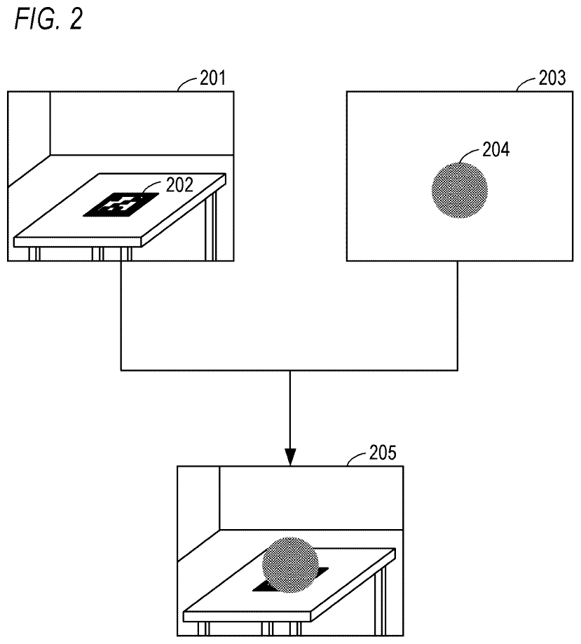

Here, the process of generating a composite image from the captured image and the virtual space image will be described with reference to FIG. 2. The captured image 201 includes a marker 202 that is artificially placed in the real space (FIG. 2 shows only one marker for simplicity of explanation, but in practice, a plurality of markers are included). The computer device 103 extracts the marker 202 from the captured image 201, and calculates the position and orientation of the HMD 101 based on the extracted marker 202 and the orientation information received from the controller 102. The computer device 103 then generates an image 203 that represents the virtual space as seen from a viewpoint (corresponding to the viewpoint of the HMD wearer) having the calculated position and orientation. The image 203 includes a virtual object 204. The computer device 103 then generates an image 205 of mixed reality space, which is a composite image acquired by combining the captured image 201 and the image 203 of the virtual space, and transmits the generated image 205 to the HMD 101 via the controller 102. Note that when combining the captured image 201 and the image 203 of the virtual space, information about the depth in the three-dimensional space or information about the transparency of the virtual object 204 may be used. In this way, a composite image 205 that reflects the front-rear relationship between a real object and the virtual object 204, or a composite image 205 in which the virtual object 204 is combined in a semi-transparent state can be generated.

In FIG. 1, the computer device 103 and the controller 102 are separate devices, but the computer device 103 and the controller 102 may be integrated. In the present embodiment, a form in which the computer device 103 and the controller 102 are integrated will be described. In the following, the device in which the computer device 103 and the controller 102 are integrated will be referred to as the image processing device 104.

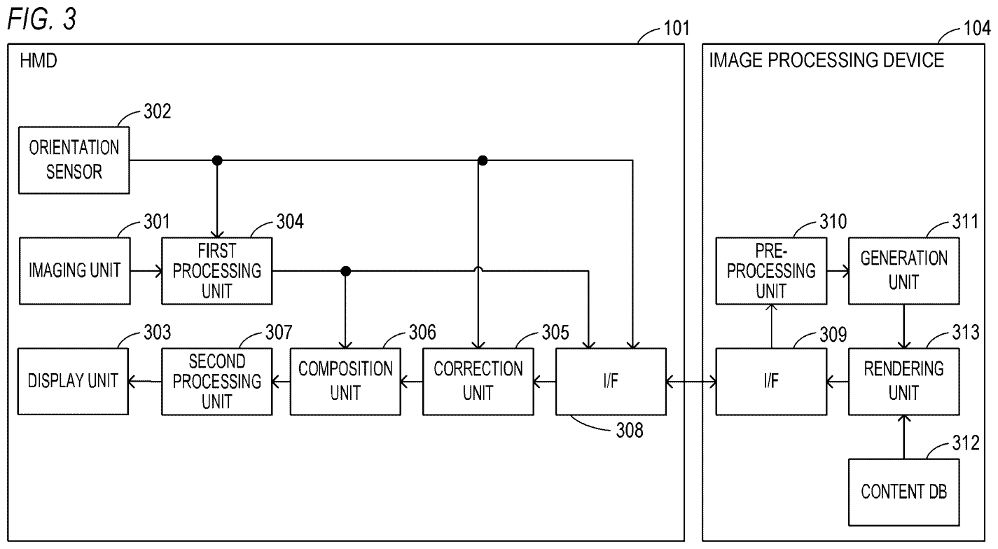

Next, examples of the functional configurations of the HMD 101 and the image processing device 104 will be described using the block diagram of FIG. 3. First, the HMD 101 will be described. The HMD 101 has an imaging unit 301, an orientation sensor 302, a display unit 303, a first processing unit 304, a correction unit 305, a composition unit 306, a second processing unit 307, and an I/F 308.

The imaging unit 301 captures the real space to acquire a captured image. The imaging unit 301 of the present embodiment is used for acquiring both a background image to be combined with a virtual space image and an alignment image to be used for generating position and orientation information. The imaging unit 301 has a left-eye imaging unit and a right-eye imaging unit. The left-eye imaging unit captures a real space moving image corresponding to the left eye of the wearer of the HMD 101, and the left-eye imaging unit outputs an image (captured image) of each frame in the moving image. The right-eye imaging unit captures a real space moving image corresponding to the right eye of the wearer of the HMD 101, and the right-eye imaging unit outputs an image (captured image) of each frame in the moving image. That is, the imaging unit 301 acquires captured images as stereo images having a parallax that approximately matches the parallax between the left eye and the right eye of the wearer of the HMD 101. In addition, in an HMD for an MR system, it is preferable to arrange the central optical axis of the imaging range of the imaging unit so as to approximately match the line-of-sight direction of the wearer of the HMD.

Each of the left-eye imaging unit and the right-eye imaging unit has an optical system and an imaging device. Light entering from the outside world enters the imaging device via the optical system, and the imaging device outputs an image corresponding to the entering light as a captured image. As the imaging device, for example, an imaging element such as a CMOS sensor or a CCD sensor is used.

The orientation sensor 302 detects the orientation of the imaging unit 301 to acquire orientation information. In the present embodiment, the orientation sensor 302 measures various types of data required to calculate the position and orientation of the imaging unit 301 (HMD 101) and outputs the measured orientation information. The orientation sensor 302 is implemented by a magnetic sensor, an ultrasonic sensor, an acceleration sensor, an angular velocity sensor, and the like.

The display unit 303 has a right-eye display unit and a left-eye display unit. The mixed reality space left-eye image is displayed on the left-eye display unit, and the mixed reality space right-eye image is displayed on the right-eye display unit. The left-eye display unit and the right-eye display unit each have a display optical system and a display element. The display optical system may be a decentered optical system such as a free-form prism, or a normal coaxial optical system or an optical system with a zoom mechanism. The display element may be, for example, a small liquid crystal display, an organic EL display, or a retina scan-type device using MEMS. Light from the image displayed on the display element enters the eye of the wearer of the HMD 101 via the display optical system.

The first processing unit 304 performs various types of image processing on the captured image acquired by the imaging unit 301. Here, the image processing for generating a background image used for combining the display image to be displayed on the display unit 303 and the image processing for generating an alignment image used for generating the position and orientation information in the generation unit 311 may be different from each other.

The correction unit 305 performs a correction process based on a change in the orientation information of the orientation sensor 302 for the virtual image received from the image processing device 104 via the I/F 308. The correction unit 305 detects a change in the viewpoint position and direction of the HMD wearer based on the orientation information associated with the captured image used for generating the position and orientation information for rendering the virtual image and the orientation information associated with the newer captured image used for combining the display image. If the amount of change is equal to or greater than a specified value (a predetermined threshold value), the correction unit 305 performs a process of correcting the shape, size, and the like of the virtual image as observed from the viewpoint of the HMD wearer after the change. This process includes shifting in the horizontal and vertical directions, changing the size by enlarging or reducing, or performing geometric transformation such as homography transformation. That is, the correction unit 305 estimates the movement of the HMD (viewpoint) based on the orientation information of different frames, and performs correction according to the movement of the HMD on the virtual image generated from the captured image of the past frame, thereby generating a virtual image corresponding to the current position and orientation of the HMD. The correction process in the correction unit 305 can be performed at a frame rate higher than the frame rate of the virtual image generated by the rendering unit 313. For example, if the virtual image is generated at 60 fps and the HMD 101 supports image capturing and display at 120 fps, the correction unit 305 detects changes in the position and orientation of the HMD wearer at each arrival timing of the captured image used for composition, and corrects the virtual image. In this way, it is possible to achieve a higher frame rate for the entire system from image capturing to display, even when a sufficient frame rate cannot be achieved due to high-load processing such as the calculation processing for generating position and orientation information and the processing of rendering the virtual space image.

The composition unit 306 combines the virtual image corrected by the correction unit 305 with the captured image output from the imaging unit 301 to generate a display image. The composition unit 306 performs processing such as chromakey composition and alpha blending, and may also perform more advanced composition processing that reflects the front-rear relationship between the captured image and the virtual image by using depth information.

The second processing unit 307 performs various types of image processing on the display image generated by the composition unit 306. Examples of the image processing performed here include offset and gain adjustment processing, pixel defect correction, and distortion correction processing of the display optical system. These are processes for correcting individual variations in the display device and display optical system that constitute the display unit 303.

The captured image output from the imaging unit 301 and the orientation information output from the orientation sensor 302 are both transmitted to the image processing device 104 via the I/F 308.

Next, the image processing device 104 will be described. The image processing device 104 has an I/F 309, a pre-processing unit 310, a generation unit 311, a content DB 312, and a rendering unit 313.

The image processing device 104 receives the captured image and orientation information transmitted from the HMD 101 via the I/F 309. The pre-processing unit 310 performs image processing on the captured image received from the HMD 101 via the I/F 309 as pre-processing for generating position and orientation information in the generation unit 311.

The generation unit 311 extracts (recognizes) feature information from the captured left-eye image and the captured right-eye image that have been subjected to image processing by the first processing unit 304 and the pre-processing unit 310. The feature information is information that can be a clue to understanding the three-dimensional structure (geometric structure) such as the position, shape, and orientation of the subject or background in the captured image, and may use natural feature points or a predetermined marker. Alternatively, a visible or invisible pattern light may be irradiated to obtain a captured image, and the pattern in the captured image may be extracted as feature information. The generation unit 311 then acquires the respective positions and orientations of the left-eye imaging unit and the right-eye imaging unit based on the extracted feature information and the orientation information received from the HMD 101 via the I/F 309. The process for acquiring the position and orientation of the imaging unit based on the markers in the image and the position and orientation measured by a sensor provided in the HMD together with the imaging unit that captured the image is well known, so a description of this technology will be omitted.

The content DB (database) 312 stores various types of data (virtual space data) necessary for rendering an image of a virtual space. The virtual space data includes, for example, data that defines each virtual object constituting the virtual space (for example, data that defines the geometric shape, color, texture, arrangement position and orientation of the virtual object). The virtual space data also includes, for example, data that defines a light source disposed in the virtual space (for example, data that defines the type, position and orientation of the light source).

The rendering unit 313 constructs a virtual image using the virtual space data stored in the content DB 312. The rendering unit 313 then generates an image (left) of the virtual space as viewed from a viewpoint having the position and orientation of the left-eye imaging unit acquired by the generation unit 311. The rendering unit 313 also generates an image (right) of the virtual space as viewed from a viewpoint having the position and orientation of the right-eye imaging unit acquired by the generation unit 311. The rendering unit 313 then transmits the virtual space image (left) and the virtual space image (right) to the HMD 101 via the I/F 309.

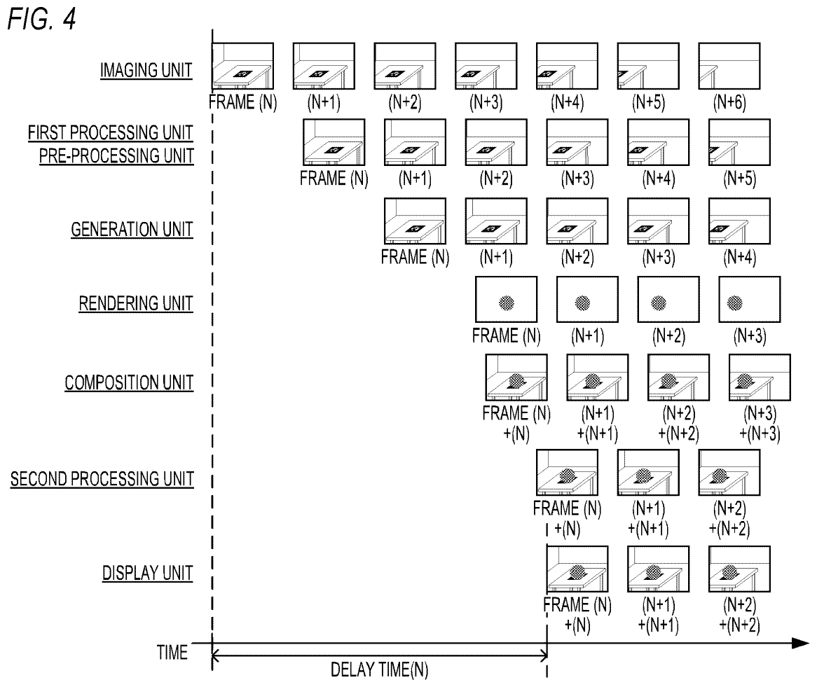

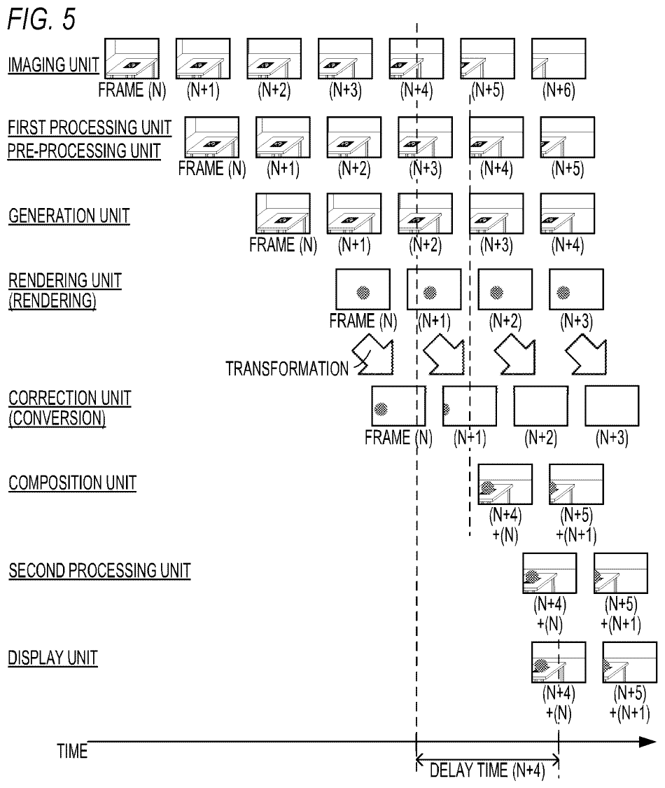

Next, the reduction in delay time according to the present embodiment will be described with reference to FIGS. 4 and 5. In FIGS. 4 and 5, the horizontal axis is time. FIG. 4 is a diagram for explaining the delay time (that is, equivalent to the delay time in the conventional technology) of an MR system that does not have a correction unit for correcting the virtual space image using the orientation information.

The imaging unit 301 sequentially acquires captured images of frame (N), frame (N+1), and frame (N+2).

The first processing unit 304 and the pre-processing unit 310 perform various types of image processing including pre-processing required for the generation unit 311 to acquire the position and orientation, and the delay time including the transmission delay in the I/F 308 and the I/F 309 is added to each frame.

The generation unit 311 performs processing for acquiring the position and orientation of the HMD 101 using the captured image and orientation information, the rendering unit 313 performs rendering of a virtual space image from the acquired position and orientation, and the processing time is added as a delay time.

The composition unit 306 combines the captured image and the virtual space image. Here, in order to match the temporal consistency of the captured image that serves as the background and the virtual space image, the captured image used for generating the position and orientation for rendering the virtual space image and the captured image used as the background for the composite image are the captured image of the same frame (N).

The second processing unit 307 performs various types of image processing on the composite image generated by the composition unit 306, and the processing time is added as a delay time. Then, the composite image is displayed on the display unit 303.

At this time, the time taken from the start of acquisition of the captured image of frame (N) to the start of displaying the composite image of frame (N) is represented by a delay time (N).

FIG. 5 is a diagram explaining the delay time of an MR system having a correction unit for correcting a virtual space image using orientation information.

The captured images of frame (N), frame (N+1), and frame (N+2) are acquired sequentially by the imaging unit 301. The first processing unit 304 and the pre-processing unit 310 perform various types of image processing including pre-processing required for the generation unit 311 to acquire the position and orientation. The generation unit 311 performs processing for acquiring the position and orientation of the HMD 101 using the captured images and the orientation information, and the rendering unit 313 renders a virtual space image from the acquired position and orientation. The processing up to this point is the same as that shown in FIG. 4.

The correction unit 305 estimates a change in the position and orientation of the HMD 101 based on a change between past orientation information used in generating the position and orientation for rendering a virtual space image by the rendering unit 313 and the orientation information associated with the current captured image. Then, the correction unit 305 executes a correction process (conversion process) on the virtual space image according to the amount of change in the position and orientation.

The composition unit 306 combines the captured image of the latest frame (N+4) with the corrected virtual space image of the frame (N). Thus, in the MR system according to the present embodiment, the captured image used in generating the position and orientation for rendering a virtual space image and the captured image used as the background of the composite image are not the same image (captured image of the same frame). That is, the virtual space image to be combined with the captured image of the latest frame (N+4) used as the background of the composite image is generated based on the captured image of the past frame (N). In this way, the delay time from when the captured image of frame (N+4) is captured until the composite image is generated using the captured image of frame (N+4) is reduced compared to the conventional method (FIG. 4).

Furthermore, the second processing unit 307 performs various types of image processing on the generated composite image, and the processing time is added as the delay time. The composite image is then displayed on the display unit 303.

At this time, the time taken from the start of capturing the captured image of frame (N+4) until the start of displaying the composite image of frame (N+4) is represented by the delay time (N+4). Comparing the delay time (N) in FIG. 4 with the delay time (N+4) in FIG. 5, it can be seen that the application of the correction processing based on the change in the orientation information significantly reduces the delay time from capturing the background image to displaying the composite image.

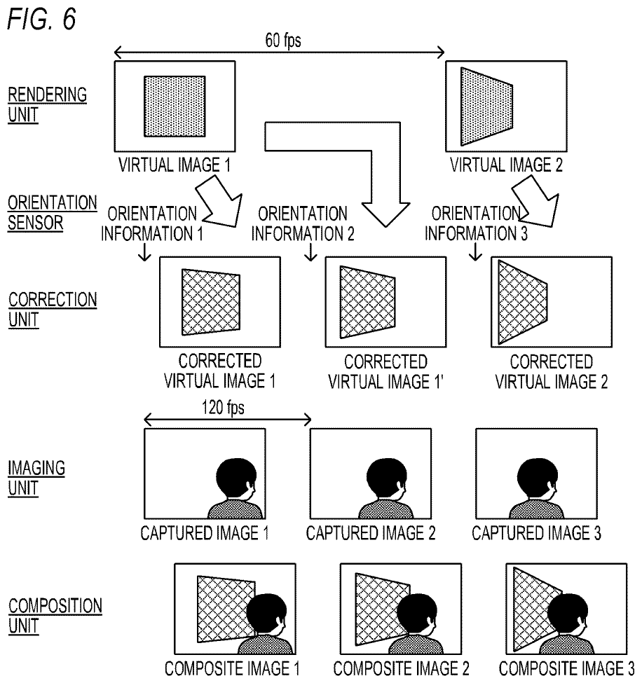

Next, the correction processing based on the change in the orientation information according to the present embodiment will be described with reference to FIG. 6. The horizontal direction in FIG. 6 represents the passage of time. However, the numbers “1”, “2”, and “3” added after the image names and information names in FIG. 6 are symbols for distinguishing individual images or information, and do not indicate frame numbers.

The imaging unit 301 acquires captured images 1, 2, and so on at a predetermined cycle (for example, 120 fps here). The orientation sensor 302 acquires orientation information 1, 2, and so on corresponding to the captured images 1, 2, and so on. The rendering unit 313 renders virtual images 1, 2, and so on at a predetermined cycle (for example, 60 fps here) based on the positions and orientations calculated using the captured images and the orientation information.

The correction unit 305 corrects the virtual image 1 based on the orientation information 1 associated with the captured image 1 to generate a corrected virtual image 1, and further corrects the virtual image 1 based on the orientation information 2 associated with the captured image 2 to generate a corrected virtual image 1′. Next, the correction unit 305 corrects the virtual image 2 based on the orientation information 3 associated with the captured image 3 to generate a corrected virtual image 2, and further corrects the virtual image 2 based on the orientation information 4 associated with the captured image 4 (not shown) to generate a corrected virtual image 2′.

The composition unit 306 combines the captured image 1 and the corrected virtual image 1, the captured image 2 and the corrected virtual image 1′, and the captured image 3 and the corrected virtual image 2, respectively, to generate the composite image 1, the composite image 2, and the composite image 3, and displays them on the display unit 303. In this way, the correction unit 305 performs frame interpolation of the virtual image in accordance with the frame rate of the captured image, so that a high-quality composite image can be displayed at a high frame rate and with a low latency.

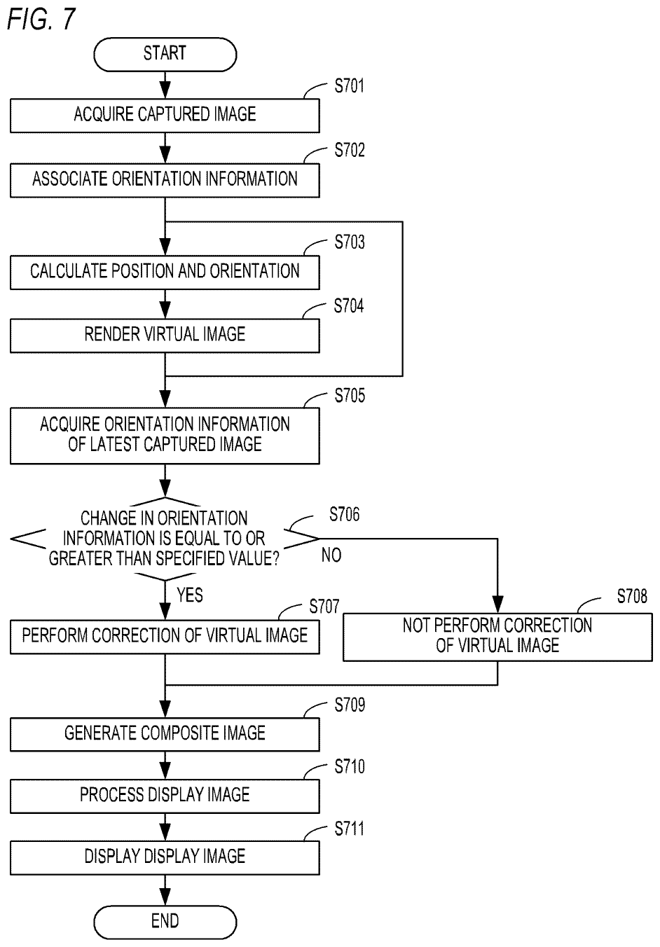

The processing flow of the MR system according to the present embodiment will be described with reference to the flowchart in FIG. 7.

In step S701, the imaging unit 301 acquires a captured image of a real space.

In step S702, the orientation sensor 302 performs a process of associating the orientation information acquired at a timing that is the same as or closest to the timing of the capture of the captured image by the imaging unit 301 with the captured image. Note that the process of associating the captured image with the orientation information may be performed by a control unit (not shown) instead of the orientation sensor 302. The captured image and the orientation information are transmitted to the image processing device 104.

In step S703, the generation unit 311 extracts feature information (such as natural feature points and markers) from the captured image, and calculates the position and orientation of the imaging unit 301 based on the feature information and the orientation information.

In step S704, the rendering unit 313 constructs a virtual image using virtual space data stored in the content DB 312 based on the position and orientation calculated by the generation unit 311.

In step S705, the correction unit 305 acquires, from the orientation sensor 302, orientation information associated with the latest captured image used by the composition unit 306 to combine the display image.

In step S706, it is determined whether the change between the orientation information associated with the captured image used for generating the position and orientation information for rendering the virtual image and the orientation information associated with the latest captured image used for combining the display image is equal to or greater than a specified value. If the result of this determination indicates that the change in the orientation information is equal to or greater than the specified value, the process proceeds to step S707. On the other hand, if the change in the orientation information is not equal to or greater than the specified value, the process proceeds to step S708.

In step S707, the correction unit 305 performs a process of correcting the shape, size, and the like of the virtual image as observed from the viewpoint of the HMD wearer after the change in orientation information. In step S708, the correction unit 305 proceeds to step S709 without correcting the virtual image.

Here, the processes of steps S706, S707, and S708 determine whether or not to correct the virtual image depending on whether or not the change in the orientation information is equal to or greater than the specified value. This is because when the movement of the viewpoint of the HMD wearer is small, the amount of deformation of the virtual image is also small, and the effect of the correction is hardly felt. In this way, by not performing correction when the movement of the viewpoint of the HMD wearer is small, it is possible to reduce the processing load and obtain a power saving effect.

However, the determination of whether or not to correct the virtual image by the correction unit 305 according to the present embodiment is not limited to this. For example, a configuration may be considered in which if the change in the orientation information is equal to or less than a second specified value, the virtual image is corrected, and if the change in the orientation information is not equal to or less than the second specified value, the virtual image is not corrected. This is because if the viewpoint movement is extremely large, such as when the HMD wearer quickly turns his/her head, the display image itself during the movement cannot be correctly recognized, and the effect of correction is not obtained. In addition, in determining whether or not to correct the virtual image by the correction unit 305 according to the present embodiment, the correction unit 305 may further determine whether or not to correct the virtual image depending on whether or not the change in the orientation information is within a specified range. By not performing correction according to the magnitude of the change in the viewpoint movement of the HMD wearer in this way, it is possible to reduce the processing load and obtain a power saving effect.

In step S709, the composition unit 306 generates a composite image by combining the latest captured image and the corrected virtual image corrected by the correction unit 305 based on the change in the orientation information.

In step S710, the second processing unit 307 performs various types of image processing on the composite image generated by the composition unit 306.

In step S711, the display unit 303 displays the composite image that has been subjected to image processing by the second processing unit 307.

In this way, the correction unit 305 corrects the virtual image based on the orientation information associated with the captured image, so that the delay time from the start of capturing the captured image to the start of displaying the display image can be significantly reduced.

Furthermore, in the present embodiment, the frame rate (display cycle) of the composite image displayed by the display unit 303 and the frame rate (imaging cycle) of the captured image acquired by the imaging unit 301 are higher than the frame rate (rendering cycle) of the virtual image rendered by the rendering unit 313. However, by generating a corrected virtual image corresponding to the imaging cycle or display cycle (for example, 120 fps here) in the correction unit 305, it is possible to realize the generation and display of a mixed reality space image at a frame rate higher than the rendering performance (rendering cycle) of the rendering unit 313.

Furthermore, in the MR system, a method of further reducing the rendering cycle to further improve the image quality of the virtual image and lengthening the time spent on rendering processing per frame can be considered. In the MR system of the present embodiment, even in such a case, the high-quality virtual image can be corrected based on the difference from the orientation information associated with the captured image, thereby enabling interpolation at a cycle corresponding to the imaging cycle of the captured image. That is, in the above-mentioned correction process example, the frame rate is doubled by generating two corrected virtual images from one virtual image, but the frame rate can be tripled or more by generating three or more corrected virtual images from one virtual image.

In the MR system of the present embodiment, periodic fluctuations such as temporary missing frames of the virtual image may occur due to fluctuations in the processing load in the processing for generating position and orientation information and the rendering processing on the image processing device 104 side. However, even in such a case, the missing virtual image can be complemented by correcting the virtual image based on the difference from the orientation information associated with the captured image.

As described above, the correction unit 305 corrects the virtual image based on the orientation information associated with the captured image, allowing the HMD wearer to enjoy a more realistic MR experience.

### Second Embodiment

In the following embodiments including the present embodiment, the differences from the first embodiment will be described, and unless otherwise specifically stated below, it will be assumed that the configuration is the same as that of the first embodiment. In the first embodiment, a configuration was described in which the correction unit 305 performs correction processing using virtual image 1 as the original image to generate corrected virtual image 1 and corrected virtual image 1′. In the present embodiment, a configuration is described in which corrected virtual image 1 is used as the original image to generate corrected virtual image 1′.

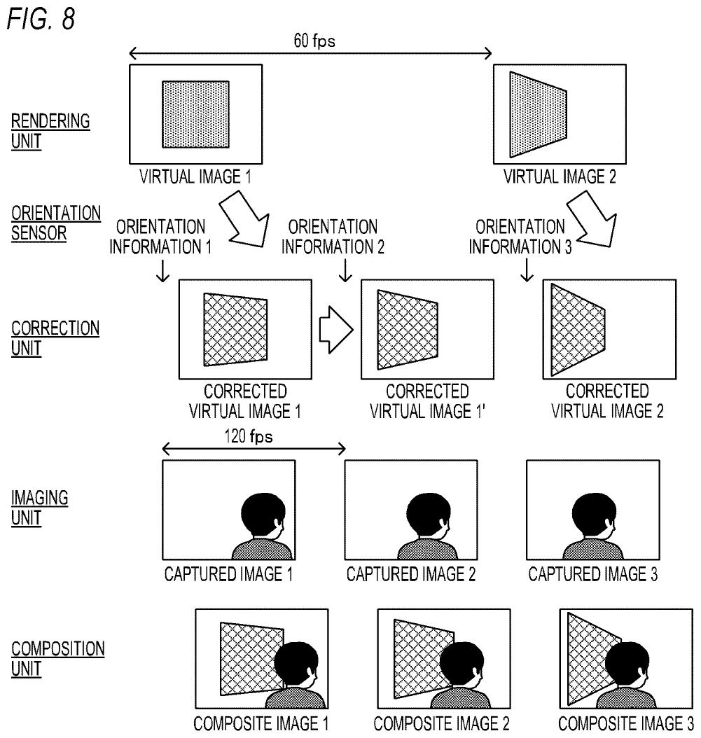

The correction processing based on the change in orientation information according to the present embodiment will be described with reference to FIG. 8. The horizontal direction in FIG. 8 represents the passage of time. However, the numbers “1”, “2”, and “3” added after the image names and information names in FIG. 8 are symbols for distinguishing individual images or information, and do not indicate frame numbers.

The imaging unit 301 acquires captured images 1, 2, and so on at a predetermined cycle (for example, 120 fps here). The orientation sensor 302 acquires orientation information 1, 2, and so on corresponding to the captured images 1, 2, and so on. The rendering unit 313 renders virtual images 1, 2, and so on at a predetermined cycle (for example, 60 fps in this case) based on the position and orientation calculated using the captured images and the orientation information.

The correction unit 305 corrects the virtual image 1 based on the orientation information 1 associated with the captured image 1 to generate a corrected virtual image 1. The correction unit 305 also corrects the corrected virtual image 1 based on the orientation information 2 associated with the captured image 2 to generate a corrected virtual image 1′. The correction unit 305 then corrects the virtual image 2 based on the orientation information 3 associated with the captured image 3 to generate a corrected virtual image 2, and further corrects the corrected virtual image 2 based on the orientation information 4 associated with the captured image 4 (not shown) to generate a corrected virtual image 2′.

The composition unit 306 combines the captured image 1 and the corrected virtual image 1, the captured image 2 and the corrected virtual image 1′, and the captured image 3 and the corrected virtual image 2, respectively, to generate the composite image 1, the composite image 2, and the composite image 3, and displays them on the display unit 303.

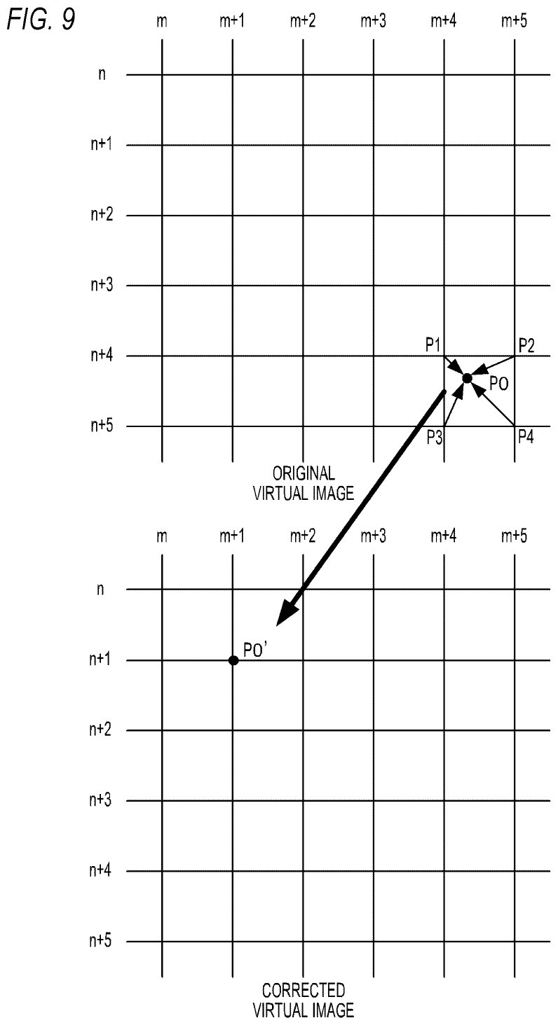

The correction process of the virtual image will now be described with reference to FIG. 9. The upper part of FIG. 9 shows the original virtual image before correction, and the lower part shows the corrected virtual image. In the present embodiment, when correcting an image, a plane is projected onto another plane using a projective transformation, for example, a homography transformation and the like, so that the image can be corrected.

The grid points of the original virtual image and the corrected virtual image represent the respective pixel coordinates. Considering the coordinates of the corrected virtual image as the reference, pixel P0′ of the corrected virtual image corresponds to pixel P0 in the original virtual image, but pixel data of the coordinates corresponding to pixel P0′ does not exist in the original virtual image. Therefore, the pixels around pixel P0, for example pixels P1, P2, P3, and P4 in this example, are weighted according to the relative distance between each of pixels P1 to P4 and pixel P0, and the weighted sum is divided by 4 to obtain the pixel data of pixel P0′. In this way, the pixel data of each pixel of the corrected virtual image is acquired by calculating pixel data for all pixels of the corrected virtual image using the peripheral pixel data of the original virtual image. Here, the pixel data is sent in raster scan order, that is, after sending the pixel data of the n-th row from coordinate (n, m) to coordinate (n, m+5), the pixel data of the (n+1)th row, the pixel data of the (n+2)th row, and so on. Therefore, the correction unit 305 cannot start the process of calculating the pixel data of pixel P0′ at coordinate (n+1, m+1) of the corrected virtual image until the pixel data of the (n+5)th row including pixels P3 and P4 of the original virtual image is input. Memory capacity is required to hold the pixel data of the original virtual image, and the time until the process of acquiring pixel data of pixel P0′ of the corrected virtual image is started is a delay time. The larger the deformation amount of the corrected virtual image, the larger the distance in the row direction between pixel P0 of the original virtual image and pixel P0′ of the corrected virtual image becomes, so that a larger memory capacity is required and the delay time related to the process also increases.

In the present embodiment, the corrected virtual image 1 is used as the original image when the correction unit 305 corrects the virtual image based on the orientation information 2 associated with the captured image 2. Therefore, the deformation amount between the original image and the corrected virtual image is smaller than when the correction is performed using virtual image 1 as the original image as in the first embodiment. Therefore, the required memory capacity is reduced compared to the method of the first embodiment, and the delay time related to the process is further reduced.

In this way, by using the corrected virtual image 1 as the original image to generate the corrected virtual image 1′ in the correction unit 305, the memory capacity required for the correction process can be reduced and the delay time from the start of imaging to the start of display can be reduced. Also, as in the first embodiment, it is possible to generate a corrected virtual image equivalent to the imaging cycle of the captured image (for example, 120 fps in this case), and the frame rate of the entire system can be improved beyond the rendering performance. Therefore, the HMD wearer can enjoy a more realistic MR experience.

### Third Embodiment

In the first and second embodiments, the captured image acquired by the imaging unit 301 is used as a background image used for combining the display image to be displayed on the display unit 303, and also as an alignment image used for generating position and orientation information by the generation unit 311. In the present embodiment, a configuration having a separate imaging unit for alignment images in addition to the imaging unit 301 for background images will be described.

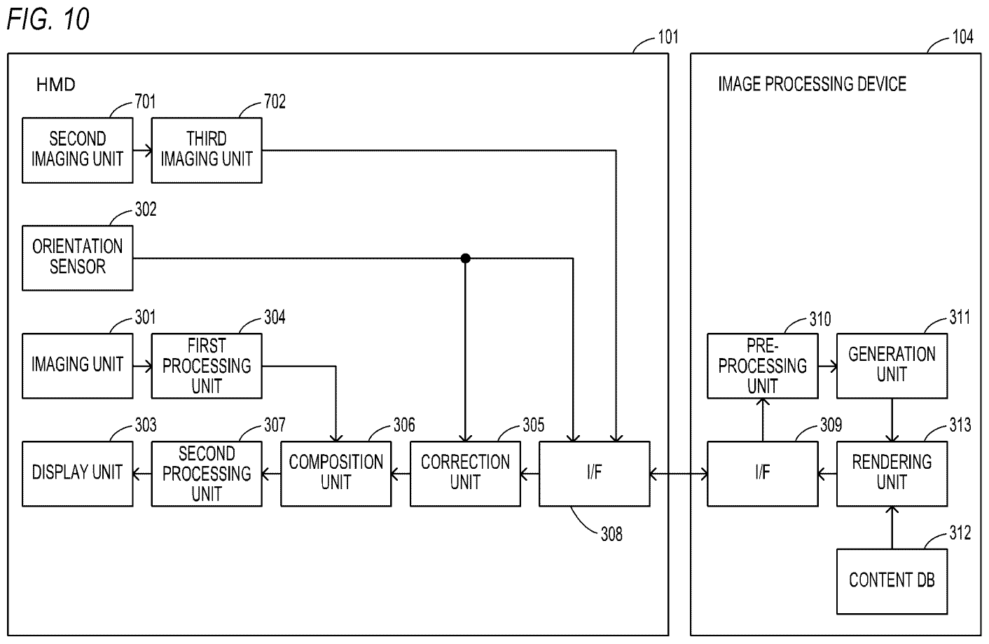

An example of the functional configuration of the HMD 101 and the image processing device 104 will be described with reference to the block diagram of FIG. 10. First, the HMD 101 will be described. The HMD 101 of the present embodiment has an imaging unit 301, an orientation sensor 302, a display unit 303, a first processing unit 304, a correction unit 305, a composition unit 306, a second processing unit 307, an I/F 308, a second imaging unit 701, and a third processing unit 702. The same reference numerals are used to designate components corresponding to those of the first embodiment.

The imaging unit 301 is for capturing a real space image to be combined with a virtual space image, and has a left-eye imaging unit and a right-eye imaging unit. The imaging unit 301 acquires captured images as stereo images having a parallax that is approximately equal to the parallax between the left eye and the right eye of the wearer of the HMD 101.

The second imaging unit 701 has a plurality of imaging units for capturing alignment images used for generating position and orientation information, and acquires captured images as stereo images with parallax. Each imaging unit captures a real space moving image, and outputs an image (captured image) of each frame in the moving image. Each imaging unit of the second imaging unit 701 has an optical system and an imaging device. Light entering from the outside world enters the imaging device via the optical system, and the imaging device outputs an image corresponding to the light as a captured image. As the imaging device, for example, an imaging element such as a CMOS sensor or a CCD sensor is used.

Here, the imaging unit 301 of the HMD 101 and the second imaging unit 701 may use a rolling shutter-type imaging element and a global shutter-type imaging element in consideration of various factors such as the number of pixels, image quality, noise, sensor size, power consumption, and cost. Alternatively, they may be used in combination depending on the application. For example, a rolling shutter-type image sensor capable of acquiring higher quality images may be used for capturing an image to be combined with an image of a virtual space, and a global shutter-type image sensor without image smear may be used for capturing natural feature points and markers. Image smear is a phenomenon that occurs due to the operating principle of the rolling shutter type, in which exposure processing is started sequentially for each line in the scanning direction. Specifically, it is known as a phenomenon in which a subject is recorded in a distorted manner when the imaging unit or subject moves during the exposure time due to a temporal deviation in the exposure timing of each line. In the case of the global shutter type, exposure processing is performed simultaneously for all lines, so there is no temporal deviation in the exposure timing of each line and no image smear occurs.

In the MR system according to the present embodiment, a rolling shutter-type image sensor is used as the imaging device of the imaging unit 301, and a global shutter-type image sensor is used as the imaging device of the second imaging unit 701.

The orientation sensor 302 measures various types of data necessary to acquire the position and orientation of the device itself, and outputs the measured orientation information. The display unit 303 has a right-eye display unit and a left-eye display unit. The first processing unit 304 performs various types of image processing on the captured image acquired by the imaging unit 301. Here, image processing is performed to generate a background image used for combining the display image to be displayed on the display unit 303.

The third processing unit 702 performs various types of image processing on the captured image acquired by the second imaging unit 701. Here, image processing is performed to generate an alignment image used for generating position and orientation information by the generation unit 311.

The correction unit 305 performs correction processing on the virtual image received from the image processing device 104 via the I/F 308 based on changes in the orientation information of the orientation sensor 302. The correction processing can be performed using a method similar to that of the MR system in the first and second embodiments. The correction processing in the correction unit 305 can be performed at a frame rate higher than the frame rate of the virtual space image generated by the rendering unit 313. For example, if the virtual image is generated at 60 fps and the HMD 101 supports imaging and display at 120 fps, the correction unit 305 detects changes in the viewpoint position and orientation of the HMD wearer at each arrival timing of the captured image used for composition, and corrects the virtual image. In this way, it is possible to achieve a higher frame rate for the entire system from imaging to display, even when a sufficient frame rate cannot be achieved in high-load processing such as the computational processing for generating position and orientation information or the processing for rendering a virtual space image.

The composition unit 306 combines the virtual image corrected by the correction unit 305 and the captured image output from the imaging unit 301 to generate a display image. The second processing unit 307 performs various types of image processing on the display image generated by the composition unit 306. The captured image output from the second imaging unit 701 and the orientation information output from the orientation sensor 302 are both transmitted to the image processing device 104 via the I/F 308.

Next, the image processing device 104 will be described. The image processing device 104 has an I/F 309, a pre-processing unit 310, a generation unit 311, a content DB 312, and a rendering unit 313.

The image processing device 104 receives the captured image and the orientation information transmitted from the HMD 101 via the I/F 309. The pre-processing unit 310 performs image processing on the captured image acquired by the second imaging unit 701 received from the HMD 101 via the I/F 309 as pre-processing for generating position and orientation information in the generation unit 311.

The generation unit 311 extracts (recognizes) feature information (natural feature points, markers, and the like) from the captured left-eye image and the captured right-eye image that have been image-processed by the third processing unit 702 and the pre-processing unit 310. The generation unit 311 then determines the respective positions and orientations of the left-eye imaging unit and the right-eye imaging unit based on the extracted feature information and the orientation information received from the HMD 101 via the I/F 309.

The content DB (database) 312 stores various types of data (virtual space data) required for rendering images in a virtual space.

The rendering unit 313 constructs a virtual image using the virtual space data stored in the content DB 312. Then, the rendering unit 313 generates an image (left) of the virtual space seen from a viewpoint having the position and orientation of the left-eye imaging unit acquired by the generation unit 311. The rendering unit 313 also generates an image (right) of the virtual space seen from a viewpoint having the position and orientation of the right-eye imaging unit acquired by the generation unit 311. Then, the rendering unit 313 transmits the virtual space image (left) and the virtual space image (right) to the HMD 101 via the I/F 309.

In this way, by configuring the imaging unit 301 and the second imaging unit 701 of the HMD 101 separately and selecting the optimal device for each according to the purpose of the background image and the alignment image, it is possible to provide a high-quality background display image while achieving high alignment accuracy. Therefore, the HMD wearer can enjoy a more realistic MR experience. In addition, the process for acquiring the position and orientation using the alignment image generally has a high computational load, and if the alignment image has a large number of pixels, it may not be possible to achieve a sufficient frame rate. For this reason, a device with a small number of pixels may be selected as the second imaging unit 701 for acquiring the alignment image. Furthermore, in the case where the rendering frame rate of the rendering unit 313 is limited to 60 fps as in the MR system according to the present embodiment, a frame rate of 60 fps for the alignment image used for generating the position and orientation information is sufficient. In other words, by reducing the number of pixels of the second imaging unit 701 for acquiring the alignment image and setting the frame rate to 60 fps, the amount of image data transmitted from the HMD 101 to the image processing device 104 can be reduced. By reducing the amount of data transmitted, the transmission cable between the I/F 308 and the I/F 309 can be made thinner, and wireless communication can also be supported.

### Fourth Embodiment

The functional units of the HMD 101 and the image processing device 104 shown in FIGS. 3 and 10 may be implemented in hardware, or some of the functional units may be implemented in software (computer programs).

In the latter case, the imaging unit 301, the second imaging unit 701, the orientation sensor 302, the display unit 303, and the I/F 308 in the HMD 101 may be implemented in hardware, and the remaining functional units may be implemented in software. In this case, the software is stored in the memory of the HMD 101, and the processor of the HMD 101 executes the software to realize the functions of the corresponding functional units.

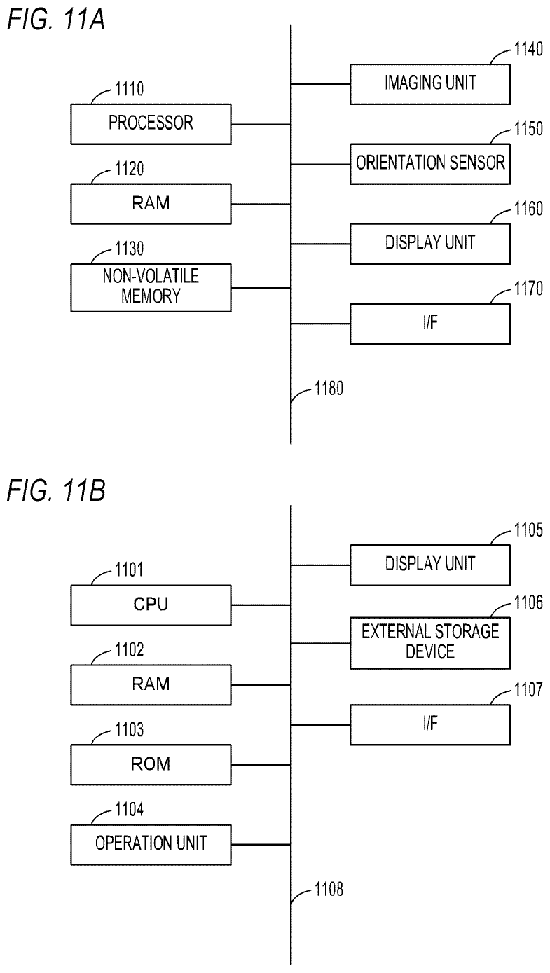

An example of the hardware configuration of the HMD 101 will be described using the block diagram in FIG. 11A. The HMD 101 has, as hardware resources, a processor 1110, a RAM 1120, a non-volatile memory 1130, an imaging unit 1140, an orientation sensor 1150, a display unit 1160, and an I/F 1170.

The processor 1110 executes various types of processing using the computer programs and data stored in the RAM 1120. In this way, the processor 1110 controls the operation of the entire HMD 101, and executes or controls each of the processes described above as being performed by the HMD 101.

The RAM 1120 has an area for storing computer programs and data loaded from the non-volatile memory 1130, and an area for storing data received from the image processing device 104 via the I/F 1170. The RAM 1120 also has a work area used by the processor 1110 when executing various types of processing. In this way, the RAM 1120 can provide various areas as appropriate.

The non-volatile memory 1130 non-temporarily stores computer programs and data for causing the processor 1110 to execute or control the operation of the HMD 101. The computer programs include computer programs for causing the CPU 1101 to execute the functions of the functional units (excluding the imaging unit 301, the second imaging unit 701, the orientation sensor 302, the display unit 303, and the I/F 308) of the HMD 101 shown in FIGS. 3 and 10. The computer programs and data stored in the non-volatile memory 1130 are loaded into the RAM 1120 as appropriate under the control of the processor 1110, and become the subject of processing by the processor 1110.

The imaging unit 1140 includes the imaging unit 301 and the second imaging unit 701 shown in FIGS. 3 and 10. The orientation sensor 1150 includes the orientation sensor 302 shown in FIGS. 3 and 10. The display unit 1160 includes the display unit 303 shown in FIGS. 3 and 10. The I/F 1170 includes the I/F 308 shown in FIGS. 3 and 10. The processor 1110, RAM 1120, non-volatile memory 1130, imaging unit 1140, orientation sensor 1150, display unit 1160, and I/F 1170 are all connected to the bus 1180. Note that the configuration shown in FIG. 11A is an example of a configuration applicable to the HMD 101, and can be changed/modified as appropriate.

Next, an example of the configuration of the image processing device 104 will be described. The image processing device 104 can be configured by a computer device capable of executing software corresponding to the functional units (excluding the I/F 309 and the content DB 312) shown in FIGS. 3 and 10. An example of the hardware configuration of a computer device applicable to the image processing device 104 will be described using the block diagram of FIG. 11B.

The CPU 1101 executes various types of processing using the computer programs and data stored in the RAM 1102 and the ROM 1103. As a result, the CPU 1101 controls the operation of the entire computer device, and executes or controls each of the processes described above as being performed by the image processing device 104 to which the computer device is applied.

The RAM 1102 has an area for storing computer programs and data loaded from the ROM 1103 or the external storage device 1106, and an area for storing data received from the HMD 101 via the I/F 1107. The RAM 1102 also has a work area that the CPU 1101 uses when executing various types of processing. In this way, the RAM 1102 can provide various areas as appropriate. The ROM 1103 stores non-temporarily setting data and startup programs for the computer device.

The operation unit 1104 is a user interface such as a keyboard, mouse, or touch panel, and the user can input various instructions to the CPU 1101 by performing operations.

The display unit 1105 is composed of a liquid crystal screen, a touch panel screen, or the like, and can display the results of processing by the CPU 1101 using images and characters. The display unit 1105 may be a projection device such as a projector that projects images and characters.

The external storage device 1106 is a large-capacity information storage device such as a hard disk drive device or a solid state drive device. The external storage device 1106 stores an OS (operating system). The external storage device 1106 also non-temporarily stores computer programs and data for causing the CPU 1101 to execute the functions of each functional unit (except the I/F 309 and the content DB 312) of the image processing device 104 shown in FIGS. 3 and 10. The external storage device 1106 also stores the above-mentioned content DB 312.

The computer programs and data stored in the external storage device 1106 are loaded into the RAM 1102 as appropriate under the control of the CPU 1101, and become the subject of processing by the CPU 1101.

The I/F 1107 is a communication interface for data communication with the HMD 101, and functions as the I/F 309 in FIGS. 3 and 10. In other words, this computer device performs data communication with the HMD 101 via the I/F 1107.

The CPU 1101, RAM 1102, ROM 1103, operation unit 1104, display unit 1105, external storage device 1106, and I/F 1107 are all connected to a bus 1108. Note that the configuration shown in FIG. 11B is an example of a configuration that can be applied to the image processing device 104, and can be changed/modified as appropriate.

### Fifth Embodiment

The configuration of the MR system shown in FIGS. 3 and 10 is an example. For example, the above-mentioned processes performed by the HMD 101 may be shared and executed by multiple devices, or the above-mentioned processes performed by the image processing device 104 may be shared and executed by multiple devices. In this case, the processes may be shared only by the local side (edge side) device, or the processes may be shared between the local side device and a device on the network (such as a cloud server).

In addition, instead of the head-mounted display device, a “portable device having an imaging unit, an orientation sensor, and a display unit” such as a smartphone may be used. In addition to the head-mounted display device, such a portable device may be added to the MR system. In such a case, the image processing device 104 generates an image of the mixed reality space according to the position and orientation of the head-mounted display device and delivers it to the head-mounted display device, and generates an image of the mixed reality space according to the position and orientation of the portable device and delivers it to the portable device. The method of generating an image of the mixed reality space is as in the above-described embodiment.

Furthermore, the HMD 101 and the image processing device 104 may be integrated, or instead of a head-mounted display device, the above-mentioned portable device and the image processing device 104 may be integrated.

Furthermore, in the above-described embodiment, the orientation sensor 302 is described as being included in the HMD 101, but this is not limiting, and for example, the necessary information may be acquired from images captured by an objective camera installed around the wearer of the HMD 101.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present disclosure are also included in the present disclosure. The present disclosure also includes other configurations obtained by suitably combining various features of the embodiment.

According the present disclosure, it is possible to reduce the delay time from the acquisition of a captured image up to the start of displaying the same.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-114271, filed Jul. 17, 2024, which is hereby incorporated by reference herein in its entirety.

What is claimed is:

1. An image display device comprising:
an image sensor configured to capture a real space to acquire a captured image;
an orientation sensor configured to detect an orientation of the image sensor to acquire orientation information;
one or more processors and/or circuitry configured to,
on a basis of a position and orientation of the image sensor, which are determined from a first captured image and first orientation information corresponding to the first captured image when the first captured image has been captured, perform a rendering process for rendering a first virtual image representing a virtual space as viewed from a viewpoint corresponding to the position and orientation;
perform a correction process for correcting the first virtual image on a basis of second orientation information acquired after the first orientation information, to acquire a first corrected virtual image; and
perform a composition process for combining a second captured image acquired after the first captured image with the first corrected virtual image, to acquire a composite image; and
a display configured to display the composite image.

2. The image display device according to claim 1, wherein, in the correction process, the first virtual image is corrected based on third orientation information acquired after the second orientation information, to acquire a second corrected virtual image,
in the composition process, a third captured image acquired after the second captured image and the second corrected virtual image are combined, to acquire a second composite image, and
the display displays the second composite image following the composite image.

3. The image display device according to claim 1, wherein, in the correction process, the first corrected virtual image is corrected based on third orientation information acquired after the second orientation information, to acquire a second corrected virtual image,
in the composition process, a third captured image acquired after the second captured image and the second corrected virtual image are combined to acquire, a second composite image, and
the display displays the second composite image following the composite image.

4. The image display device according to claim 1, wherein a frame rate of the composite image displayed by the display is higher than a frame rate of the virtual image rendered by the rendering process.

5. The image display device according to claim 1, wherein a frame rate of the captured image acquired by the image sensor is higher than a frame rate of the virtual image rendered by the rendering process.

6. The image display device according to claim 1, wherein the first orientation information is orientation information acquired by the orientation sensor at a timing that is the same as or closest to a timing at which the image sensor acquires the first captured image, and
the second orientation information is orientation information acquired by the orientation sensor at a timing that is the same as or closest to a timing at which the image sensor acquires the second captured image.

7. The image display device according to claim 2, wherein the third orientation information is orientation information acquired by the orientation sensor at a timing that is the same as or closest to the timing at which the image sensor acquires the third captured image.

8. The image display device according to claim 1, further comprising:
a first unit including the image sensor, the orientation sensor, and the display, and configured to perform the correction process and the composition process; and
a second unit configured to perform the rendering process,
wherein the first unit and the second unit are communicably connected to each other via a wired or wireless connection.

9. The image display device according to claim 1, wherein the image sensor includes:
a first image sensor configured to acquire a captured image used for combining the composite image; and
a second image sensor configured to acquire a captured image used for determining the position and orientation.

10. The image display device according to claim 9, wherein a frame rate of the captured image acquired by the second image sensor is lower than a frame rate of the captured image acquired by the first image sensor.

11. The image display device according to claim 1, wherein the image display device includes a head-mounted display device in which at least the image sensor, the orientation sensor, and the display are provided.

12. A method of controlling an image display device including an image sensor configured to capture a real space to acquire a captured image, an orientation sensor configured to detect an orientation of the image sensor to acquire orientation information, and a display, the method comprising:
rendering a first virtual image representing a virtual space as viewed from a viewpoint corresponding to a position and orientation of the image sensor when a first captured image has been captured, the position and orientation being determined based on the first captured image and first orientation information corresponding to the first captured image;
acquiring a first corrected virtual image by correcting the first virtual image on a basis of second orientation information acquired after the first orientation information;
acquiring a composite image by combining a second captured image acquired after the first captured image with the first corrected virtual image; and
displaying the composite image on the display.

13. A non-transitory computer readable medium that stores a program, wherein the program causes a computer to execute a method of controlling an image display device, including an image sensor configured to capture a real space to acquire a captured image, an orientation sensor configured to detect an orientation of the image sensor to acquire orientation information, and a display, the method comprising:
rendering a first virtual image representing a virtual space as viewed from a viewpoint corresponding to a position and orientation of the image sensor when a first captured image has been captured, the position and orientation being determined based on the first captured image and first orientation information corresponding to the first captured image;
acquiring a first corrected virtual image by correcting the first virtual image on a basis of second orientation information acquired after the first orientation information;
acquiring a composite image by combining a second captured image acquired after the first captured image with the first corrected virtual image; and
displaying the composite image on the display.
